(19) United States
(12) Patent Application Publication
(10) Pub. No.: US 2010/0205640 A1
(43) Pub. Date: Aug. 12, 2010

(54) DRIVE THRU VISION

(76) Inventors: Jeffrey Steinborn, Nashville, TN (US); Robert Zimmerman, Nashville, TN (US); Joyce D. Peacock, Nashville, TN (US); Bill Morton, Nashville, TN (US); Daniel Hayes, Franklin, TN (US)

Correspondence Address: CARDINAL LAW GROUP, LLC, SUITE 2000, 1603 ORRINGTON AVENUE, EVANSTON, IL, 60201, US

(21) Appl. No.: 12/370,549

(22) Filed: Feb. 12, 2009

(51) Int. Cl. H04N 7/18; G08G 1/01

(52) U.S. Cl. 725/74; 340/933

(57) ABSTRACT

Embodiments of the invention relate to a method, system and computer-readable medium for conveying audio/video information. The method detects a presence of at least one automobile and communicates such presence to an information system comprising a number of display devices (D_{N}) and an information processing unit. The processing unit contains a library of audio/video portions, each audio/video portion having a total run time (V_{TL}), where each audio/video portion is divisible into segments (V_{N}) having a segment run time (V_{SL}) such that V_{N}≦D_{N} and V_{TL}÷Dₙ=V_{SL}. The processing unit estimates a total viewing time (T_{V}) to provide the audio/video information; parses the audio/video information into D_{N} separate segments; and selects one parsed audio/video portion such that V_{TL} of the selected audio/video portion is substantially equal to T_{V.} The selected audio/video segments are communicated to the display devices.

### FIELD OF THE INVENTION

The invention relates to an advertising method and system. More particularly, the invention relates to a method and system for conveying messages to consumers in automobiles in a predetermined order.

### BACKGROUND OF THE INVENTION

In order for businesses to convey messages to consumers while in their automobiles, static advertising is strategically displayed on billboards and signs along roadways and outside of business establishments. For example, as a consumer is waiting in a line outside of a “fast-food” restaurant, the consumer may be subjected to stationary or “poster-like” advertisement that may not effectively capture the consumer's interest in the advertising. As a result, businesses do not adequately seize the opportunity to convey messages to the consumer while the consumer is traveling in an automobile along the path of a commercial enterprise's or businesses drive-thru service.

Businesses have previously failed to effectively capture the consumer's attention while the consumer is outside of the business establishment. Moreover, these businesses have also failed to provide a system to detect the presence of a consumer's automobile as it passes along the path of the business's drive-thru service such that the messages may be synchronized to change appropriately as the consumer proceeds along the path of the business's dive-thru service.

For the foregoing reasons, there is a need for a method that utilizes television monitors or displays to attract consumer's attention and dynamically convey the desired messages to the consumer while the consumer is in line at the drive-thru service. In addition, there is a need for a system that can compute the position of the consumer's automobile as it passes along the path of the drive-thru and rely the movement information to a processing unit in order to synchronize the movement of the automobile with the messages conveyed on the monitors.

### SUMMARY OF THE INVENTION

One embodiment of the present invention relates to an advertising method that satisfies the needs of businesses to effectively convey messages while consumers move along the path of a drive-thru type service. The method enables adjusting the messages as the consumer's automobile is detected and moves along the path of the drive-thru.

Another embodiment relates to an advertising method having a series of television monitors or displays placed along the path of the drive-thru outside or proximate a business establishment. The monitors' messages are synchronized with the movement of the consumer's automobile as detected by a motion sensor system. The motion sensor system allows for new messages or updated information to be displayed as the consumer proceeds along the path of the drive thru to is final destination.

Yet another embodiment relates to a method for conveying audio/video information, the method comprising detecting a presence of at least one automobile including at least one consumer and communicating the presence of the at least one automobile to an information system. The information system comprises a number of display devices, where D_{N} equals the number of display devices, and a processing unit. The display devices are positioned such that only one image provided by the display devices may be viewed from the at least one automobile at one time. The processing unit contains a library of audio/video portions, each audio/video portion having a total run time and divisible into segments, each segment has a segment run time, where V_{N} equals the number of segments, V_{TL} equals the audio/video portion total run time, V_{SL} equals the segment run time, such that V_{N}≦D_{N}. The processing unit estimates a total viewing time to provide the audio/video information, based at least on the detected presence, where T_{V} equals the total viewing time; selects at least one audio/video portion from the library of audio/video portions based at least on the estimated total viewing time such that V_{TL}≈T_{V}; and communicates the at least one selected audio/video portion to the display devices, where the display devices displays the audio/video information using at least the communicated audio/video portion.

Still another embodiment relates to a system for conveying information, the system comprising at least one motion sensor, a number of display devices and at least one processing unit. The at least one sensor is located proximate a roadway and adapted to detect a presence of at least one automobile. The number of display devices, where D_{N} equals the number of display devices, are positioned such that only one image provided by the display devices may be viewed from the at least one automobile at one time. The at least one processing unit includes an algorithm, where the processing unit communicates with the at least one sensor and D_{N} display devices, and contains a library of audio/video portions, each audio/video portion having a total run time, where each audio/video portion is divisible into segments, each segment have a segment run time, where V_{N} equals the number of segments, V_{TL} equals the audio/video portion total run time, V_{SL} equals the segment run time, such that V_{N}≦D_{N}. The processing unit estimates a total viewing time to provide the audio/video information, based at least in part on the detected presence, where T_{V} equals the total viewing time; selects at least one audio/video portion from the library of audio/video portions, based at least in part on the estimated total viewing time, such that V_{TL}≈T_{V}; and communicates the audio/video portion to the display devices, the display devices display the audio/video information using at least the communicated audio/video portion.

A still further embodiment relates to a computer-readable medium operable on a processing unit and containing one or more computer-executable instructions for conveying audio/video information. The computer-executable instructions are collectively configured to receive a signal from a sensor indicating a presence of at least one automobile and store a library of audio/video portions. Each audio/video portion has an audio/video total run time and is divisible into segments, each segment have a segment run time, where D_{N} equals the number of display devices configured to display the audio/video information, V_{N} equals the number of segments, V_{TL} equals the audio/video portion total run time, V_{SL} equals the segment run time, such that V_{N}≦D_{N}. The instructions estimate a total viewing time to provide the audio/video information based at least in part on the detected presence, where T_{V} equals the total viewing time; select at least one audio/video portion from the library of audio/video portions based at lest in part on the estimated total viewing time, such that V_{TL}≈T_{V}; and communicate the selected audio/video portion to the display devices and displaying the audio/video information using at least the communicated audio/video information.

Other embodiments comprises one or more sensors located proximate a roadway and a drive-thru service of a commercial enterprise and adapted to detect the presence of the at least one automobile. Further, the one or more sensors can detect at least one piece of information related to the at least one automobile for later use.

Embodiments are contemplated in which each audio/video portion has the same or different audio/video total run times. Further, each segment of the audio/video portion may have substantially the same segment run time, such that V_{TL}÷D_{N}=V_{SL} or a different segment run time V_{SL}.

In another embodiment, estimating the total viewing time T_{V} comprises predicting or estimating a total time for the at least one automobile to complete a drive-thru service, a time to take an order and a time to fill an order, where T_{PT} equals the total time to _{co}mplete the drive-thru service, T_{O} equals the time to take an order and T_{F} equals the time to fill an order, such that T_{PT}−T_{O}−T_{F}=T_{V}.

In one or more embodiments, the selected video portions are communicated to the display devices in a predetermined order, where only one of the D_{N} segments is communicated to each one of the display devices; one of the D_{N} segments and additional information is communicated to at least one of the display devices or more than one of the D_{N} segments is communicated to one of the display devices.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 depicts a perspective view of the system for providing drive up advertising in accordance with one embodiment of the present invention;

FIG. 2 depicts an elevational view of system of FIG.1 for providing drive up advertising in accordance with one embodiment of the present invention;

FIG. 3 depicts an elevational view of system of FIG. 1 for providing drive up advertising in accordance with another embodiment of the present invention;

FIG. 4 depicts an elevational view of display device and enclosure of FIG. 1-3 for providing drive up advertising in accordance with one embodiment of the present invention;

FIG. 5 depicts a high level flow diagram depicting a method of providing drive up advertising in accordance with one embodiment of the present invention;

Throughout the various figures, like reference numbers refer to like elements.

### DETAILED DESCRIPTION OF PRESENTLY PREFERRED EMBODIMENTS

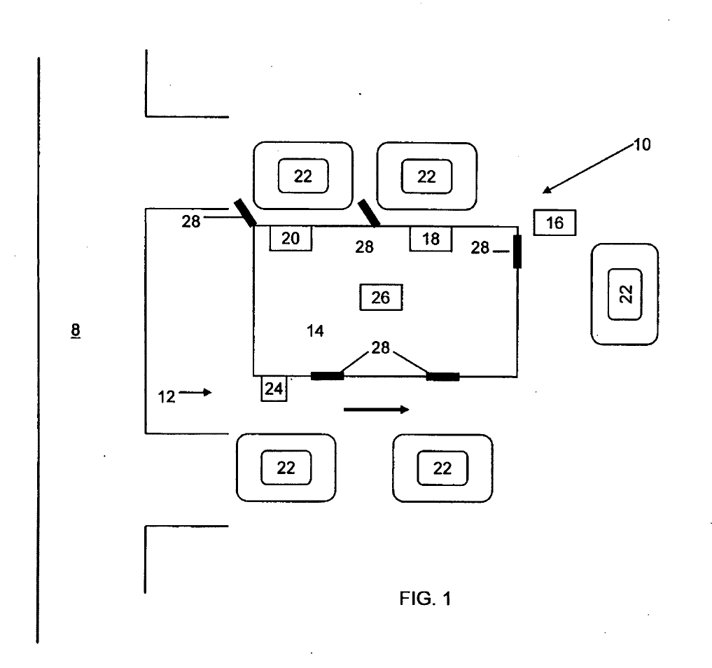

Referring to FIG. 1, one embodiment of the system, generally designated 10, is illustrated. In one embodiment, system 10 is located proximate or adjacent to roadway 8 (a predetermined distance therefrom) and conveys information to consumers in their automobiles, where automobiles includes any type of conveyance device including cars, trucks, SUVs, minivans, motorcycles, wagons, bicycles, etc. FIG. 1 depicts a drive-thru service 12 of a commercial enterprise 14 having, in this embodiment, an order speaker 16, a pay window 18 and a pick up window 20, although other arrangements are contemplated.

In this embodiment, automobile 22 is detected by one or more sensors 24 (a motion sensor for example) which communicates with processing unit 26, which may include an algorithm/computer readable medium having instructions. Further, system 10 includes D_{N} display devices or monitors 28. In FIG. 1, N=5 although a different number of display devices are contemplated.

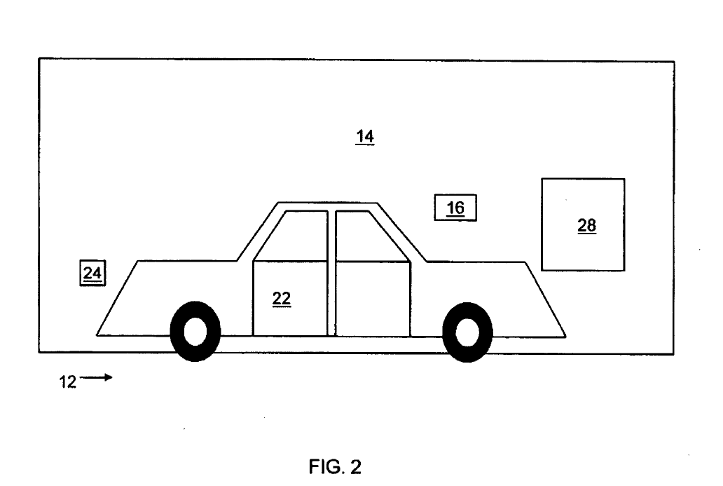

FIG. 2 depicts an elevational view of the drive-thru service 12 of a commercial enterprise 14. FIG. 2 depicts commercial enterprise 14 having sensor 24 configured to detect the presence of the at least one automobile illustrated proximate the order speaker 16, but which may be located proximate a pay window 18 and/or a pick up window 20.

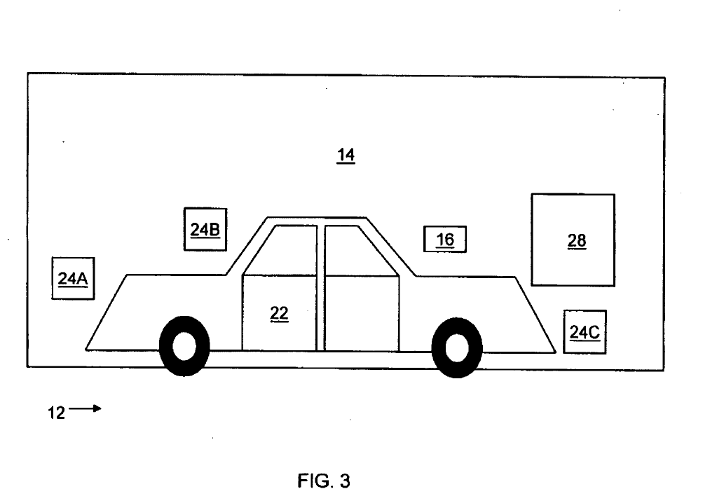

FIG. 3 depicts an elevational view of the drive-thru service of a commercial enterprise 14 similar to that depicted in FIG. 2. In this embodiment, commercial enterprise 14 is depicted having a plurality of sensors (24A, 24B and 24C) placed proximate order speaker 16, a pay window 18 and/or a pick up window 20. In this embodiment, sensors 24A-24C are configured to sense the presence of the at least one automobile, in addition to sensing other information related to the at least one automobile. For example, sensor 24A may be configured to sense information about the consumers (number of people in the automobile, number of adults, number of children, etc.); sensor 24B may be configured to sense information about the type of automobile, while sensor 24C may be configured to sense information about the license plate. The processing unit may be configured to store the sensed information for later use, i.e., used in a later order.

As illustrated, system 10 communicates audio/video information to at least one automobile containing at least one consumer. System 10 comprises a number of display devices 28, where D_{N} equals the number of display devices and at least one processing unit 26 including an algorithm, where the processing unit 26 communicates with the at least one sensor 24 and D_{N} display devices 28. In at least one embodiment, D_{N} is an integer greater than on (D_{N}>1) and only one image provided by the plurality of display devices 28 may be viewed from the automobile at one time, although other arrangements, such as enabling two or more displays to be viewed simultaneously is contemplated.

The processing unit 26 contains a library of audio/video portions where each audio/video portion is divisible into segments, where V_{N} equals the number of segments such that:

V_{N}≦D_{N} Equation 1:

Each audio/video portion has a total run time and each segment has a segment run time, where V_{TL} equals the audio/video portion total run time and V_{SL} equals the segment run time, such that:

V_{TL}÷Dₙ=V_{SL}. Equation 2:

Embodiments are contemplated in which each audio/video portion has the same or different audio/video total run times. Further, each segment of the audio/video portion may have a different segment run time V_{SL} or have substantially the same segment run time.

The processing unit 26 determines or estimates a total viewing time to provide the audio/video information based on a time estimate related to the at least one automobile, where T_{V} equals the total viewing time. The processing unit selects one audio/video portion having D_{N} separate segments from the library of audio/video portions such that:

V_{TL}≈T_{V}; Equation 3:

Where V_{TL} is the audio/video portion total run time of the selected audio/video portion.

The processing unit then communicates the D_{N} segments to the display devices, thereby conveying the audio/video information to the at least one consumer, such that the audio/video information is displayed.

In at least one embodiment, the processing unit 26 of system 10 determines a total viewing time T_{V} by predicting a total time for the at least one automobile to complete a drive-thru service, a time to take an order and a time to fill an order, where T_{PT} equals the total time to complete the drive-thru service, T_{O} equals the time to take an order and T_{F} equals the time to fill an order, such that:

T_{PT}−T_{O}−T_{F}=T_{V}. Equation 4:

Further, system 10 communicates the selected audio/video portion to the display devices 28 in a predetermined order. In at least one embodiment, the system 10 communicates the selected audio/video portion to display devices 28 in a predetermined order such that only one of the D_{N} segments is communicated to each one of the display devices 28. Additionally, the system 10 may adjust the messages as the consumer's automobile is detected and moves along the path of the drive-thru by communicating one of the D_{N} segments and additional information (sale items, upcoming provisions, previously purchased items, other menu items, other audio/video information not previously provided, advertisements from local or related commercial enterprises, etc) to at least one of the display devices 28, communicating more than one of the D_{N} segments or even communicating different or additional audio/video information.

In at least one embodiment, system 10 communicates with a central processing system (not shown). More specifically, the processing unit 26 communicates with a remote main frame or central processing unit through the Internet or other communication network (satellite network or dedicated line for example), uploading collected or sensed information and downloading new or additional audio/video portions. Additionally, the processing unit 26 may provide device status information to the remote main frame or central processing unit, thereby prompting a service call to fix any breaks.

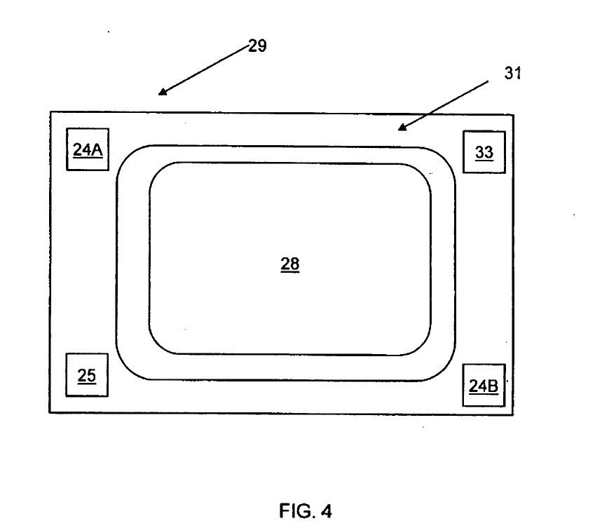

FIG. 4 depicts one embodiment of the display device 28 used in systems 10. In this embodiment, display 28 is placed or positioned in a tamper-proof enclosure or sleeve 29. In at least one embodiment illustrated in FIG. 4, enclosure 29 is formed of steel or aluminum and includes a shatter-proof, UV inhibiting window 31. In at least one embodiment, window 31 is a touch-screen or other device responsive to user input, enabling the consumer to communicate with the processing unit 26, although other means of communicating with processing unit 26 (including communication methods such as RF communication, IR communication, blue tooth communication or and Wi-Fi communication for example; and using any type of communication device such as a PDA, cell phone, computer, radio or GPS device, for example) are contemplated. Further, FIG. 4 illustrates sensors 24A and 24B positioned in enclosure 29, which may include speaker 33 providing audio information.

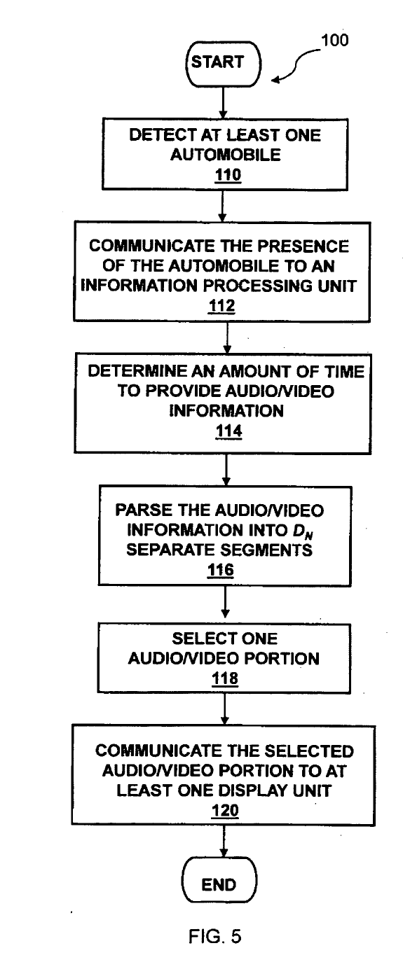

FIG. 5 depicts a method, generally designated 100, for conveying audio/video information to consumers for example. Method 100 comprises detecting a presence of at least one automobile including at least one consumer, block 110 and communicates the presence of the at least one automobile to a processing unit, block 112. In one embodiment, method 100 further comprises detecting the presence of the at least one automobile using at least one motion sensor communicating with the processing unit, where the at least one sensor and the display devices are located proximate a drive-thru service of a commercial enterprise.

In at least one embodiment, the information processing system comprises a number of display devices, where D_{N} equals the number of display devices; and a processing unit containing a library of audio/video portions, each audio/video portion divisible into segments, such that:

V_{N}≦D_{N}. Equation 1:

Each segment of the audio/video portion may have a different segment run time V_{SL} or have substantially the same segment run time, where V_{TL} equals the audio/video portion total run time and V_{SL} equals the segment run time, such that:

V_{TL}÷Dₙ=V_{SL}. Equation 2:

Embodiments are contemplated in which each audio/video portion has the same audio/video total run times.

Method 100 further comprises estimating a total viewing time to provide the audio/video information based on a time estimate related to the at least one automobile, block 114, where T_{V} equals the total viewing time. More particularly, estimating the total viewing time T_{V} comprises predicting a total time for the at least one automobile to complete a drive-thru service, a time to take an order and a time to fill an order, where T_{PT} equals the total time to complete the drive-thru service, T_{O} equals the time to take an order and T_{F} equals the time to fill an order, such that:

T_{PT}−T_{O}−T_{F}=T_{V}. Equation 4:

Method 100 additional comprises selecting one audio/video portions in D_{N} separate segments from the library of audio/video portions such that:

V_{TL}≈T_{V,} Equation 3:

where V_{TL} is the audio/video portion total run time of the selected audio/video portion.

Method 100 additionally comprises communicating the selected audio/video segments to the display devices, block 120, thereby conveying the audio/video information to the at least one consumer. In at least one embodiment, the selected audio/video portions are communicated to the display devices in a predetermined order such that only one of the D_{N} segments is communicated to each one of the display devices, one of the D_{N} segments and additional information is communicated to at least one of the display devices or the selected audio/video portions are communicated to the display devices in a predetermined order such that more than one of the D_{N} segments is communicated to one of the display devices.

Other embodiments of method 100 comprise detecting the presence of the at least one automobile using one or more motion sensors communicating with the information system, where the at least one sensor and the display devices are located proximate a drive-thru service of a commercial enterprise. Additionally, at least one piece of information related to the at least one automobile is stored.

Yet another embodiment relates to a computer-readable medium containing one or more computer-executable instructions for conveying audio/video information, the computer-executable instructions collectively configured to receive a signal from a sensor indicating a presence of at least one automobile including at least one consumer and store a library of audio/video portions. In at least one embodiment, each audio/video portion has an audio/video total run time, where each audio/video portion is divisible into segments, each segment have a segment run time, where D_{N} equals the number of display devices configured to display the audio/video information, V_{N} equals the number of segments, V_{TL} equals the audio/video portion total run time, V_{SL} equals the segment run time, such that:

V_{N}≦D_{N}. Equation 1:

Embodiments are contemplated in which each audio/video portion has the same or different audio/video total run times Further, each segment of the audio/video portion may have a different segment run time V_{SL} or have substantially the same segment run time, such that:

V_{TL}÷Dₙ=V_{SL}. Equation 2:

The computer-readable medium determines a total viewing time to provide the audio/video information based on a time estimate related to the at least one automobile, where T_{V} equals the total viewing time; selecting one audio/video portion parsed into D_{N} separate segments from the library of audio/video portions such:

V_{TL}≈T_{V,} Equation 3:

where V_{TL} is the audio/video portion total run time of the selected audio/video portion.

The computer-readable medium communicates the D_{N} segments to the display devices thereby conveying the audio/video information to the at least one consumer.

In at least one embodiment, the computer-readable medium determines a total viewing time T_{V} by predicting a total time for the at least one automobile to complete a drive-thru service, a time to take an order and a time to fill an order, where T_{PT} equals the total time to complete the drive-thru service, T_{O} equals the time to take an order and T_{F} equals the time to fill an order, such that:

T_{PT}−T_{O}−T_{F}=T_{V}. Equation 3:

Further, the selected audio/video portions are communicated to the display devices in a predetermined order such that only one of the D_{N} segments is communicated to each one of the display devices; or communicated to the display devices in a predetermined order such that one of the D_{N} segments and additional information is communicated to at least one of the display devices.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method for conveying audio/video information, the method comprising:
a) detecting a presence of at least one automobile including at least one consumer;
b) communicating the presence of the at least one automobile to an information system, the information system comprising:
1) a number of display devices, where D_{N} equals the number of display devices, such that D_{N} is greater than one and the display devices positioned such that only one image provided by the display devices may be viewed from the at least one automobile at one time; and
2) a processing unit containing a library of audio/video portions, each audio/video portion having a total run time and divisible into segments, each segment have a segment run time, where V_{N} equals the number of segments, V_{TL} equals the audio/video portion total run time, V_{SL} equals the segment run time, such that V_{N}≦D_{N};
c) estimating a total viewing time to provide the audio/video information based at least in part on the presence communicated to the information system, where T_{V} equals the total viewing time;
e) selecting at least one audio/video portion from the library of audio/video portions, based at least in part on the estimated total viewing time, such that V_{TL}≈T_{V}; and
f) communicating the at least one selected audio/video portion to the display devices and the display devices displaying the audio/video information using at least the communicated audio/video portion.

2. The method of claim 1 further comprising detecting the presence of the at least one automobile using at least one motion sensor communicating with the information system.

3. The method of claim 2 wherein the at least one sensor and the display devices are located proximate a drive-thru service of a commercial enterprise.

4. The method of claim 1, wherein estimating the total viewing time T_{V} comprises estimating a total time for the at least one automobile to complete a drive-thru service, a time to take an order and a time to fill an order, where T_{PT} equals the total time to complete the drive-thru service, T_{O} equals the time to take an order and T_{F} equals the time to fill an order, such that T_{PT}−T_{O}−T_{F}=T_{V}.

5. The method of claim 1 wherein the selected audio/video portion is communicated to the display devices in a predetermined order such that only one of the segments is communicated to each one of the display devices.

6. The method of claim 1 wherein the selected audio/video portion is communicated to the display devices in a predetermined order such that one of the segments and additional information is communicated to at least one of the display devices.

7. The method of claim 1 wherein the selected audio/video portion is communicated to the display devices in a predetermined order such that more than one of the segments is communicated to one of the display devices.

8. The method of claim 1, wherein each audio/video portion has a different audio/video total run time.

9. The method of claim 1, wherein each segment of the audio/video portion has substantially the same segment run time, such that V_{TL}÷Dₙ=V_{SL}.

10. The method of claim 1, wherein each segment of the audio/video portion has a different segment run time V_{SL}.

11. The method of claim 1 further comprising storing at least one piece of information related to the at least one automobile.

12. A system for conveying information, the system comprising:
a) at least one motion sensor located proximate a roadway and adapted to detect a presence of at least one automobile;
b) a number of display devices, where D_{N} equals the number of display devices, where the display devices are positioned such that only one image provided by the display devices may be viewed from the at least one automobile at one time; and
c) at least one processing unit including an algorithm, the processing unit communicating with the at least one sensor and D_{N} display devices, the information processing unit:
1) containing a library of audio/video portions, each audio/video portion having a total run time, where each audio/video portion is divisible into segments, each segment have a segment run time, where V_{N} equals the number of segments, V_{TL} equals the audio/video portion total run time, V_{SL} equals the segment run time, such that V_{N}≦D_{N};
2) estimating a total viewing time to provide the audio/video information based at least in part on the detected presence, where T_{V} equals the total viewing time;
3) selecting at least one audio/video portion from the library of audio/video portions, based at least in part on the estimated total viewing time, such that V_{TL}≈T_{V}; and
4) communicating the audio/video portion to the display devices, the display devices displaying the audio/video information using at least the communicated audio/video portion.

13. The system of claim 12 further comprising a plurality of sensors communicating with at least the processing unit.

14. The system of claim 12 wherein the at least one sensor and the display devices are located proximate a drive-thru service of a commercial enterprise.

15. The system of claim 11, wherein determining a total viewing time T_{V} comprises estimating a total time for the at least one automobile to complete a drive-thru service, a time to take an order and a time to fill an order, where T_{PT} equals the total time to complete the drive-thru service, T_{O} equals the time to take an order and T_{F} equals the time to fill an order, such that T_{PT}−T_{O}−T_{F}=T_{V}.

16. The method of claim 1, wherein each audio/video portion has a different audio/video total run time.

17. A computer-readable medium operable on a processing unit and containing one or more computer-executable instructions for conveying audio/video information, the computer-executable instructions collectively configured to:
a) receive a signal from a sensor indicating a presence of at least one automobile;
b) store a library of audio/video portions, each audio/video portion having an audio/video total run time, where each audio/video portion is divisible into segments, each segment have a segment run time, where D_{N} equals the number of display devices configured to display the audio/video information, V_{N} equals the number of segments, V_{TL} equals the audio/video portion total run time, V_{SL} equals the segment run time, such that V_{N}≦D_{N};
c) estimate a total viewing time to provide the audio/video information, based at least in part on the presence of at least one automobile, where T_{V} equals the total viewing time;
d) select at least one audio/video portion from the library of audio/video portions, based at least in part on the estimated total viewing time, such that V_{TL}≈T_{V}; and
e) communicate the selected audio/video portion to the display devices, and displaying the audio/video information using at least the communicated audio/video portion.

18. The computer-readable medium of claim 17, wherein determining a total viewing time T_{V} comprises estimating a total time for the at least one automobile to complete a drive-thru service, a time to take an order and a time to fill an order, where T_{PT} equals the total time to complete the drive-thru service, T_{O} equals the time to take an order and T_{F} equals the time to fill an order, such that T_{PT}−T_{O}−T_{F}=T_{V}.

19. The computer-readable medium of claim 17 wherein the selected audio/video portion is communicated to the display devices in a predetermined order such that only one of the segments is communicated to each one of the display devices.

20. The computer-readable medium of claim 17, wherein each audio/video portion has a different audio/video total run time.
